(19) United States
(12) Patent Application Publication
(10) Pub. No.: US 2009/0067176 A1
(43) Pub. Date: Mar. 12, 2009

(54) BACKLIGHT MODULE AND LIGHT GUIDE PLATE THEREOF

(75) Inventors: MENG-HUA WANG, Chu-Nan (TW); CHAO-YU HUNG, Chu-Nan (TW); CHIH-MING LAI, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/964,818

(22) Filed: Dec. 27, 2007

(30) Foreign Application Priority Data
Sep. 6, 2007 (CN) 200710201606.1

(51) Int. Cl. F21V 7/00; F21V 7/04

(52) U.S. Cl. 362/299; 362/346

(57) ABSTRACT

A backlight module (100) includes a light source (120) for emitting light therefrom, and a light guide plate (110). The light guide plate includes a light exit surface (111), a bottom surface (112) opposite to the light exit surface, a receiving hole (113) defined in the bottom surface with the light source received therein, a first reflecting surface (115) in the receiving hole facing away from the light exit surface and configured for reflecting the light emitted from the light source, a light incidence surface (116) in the receiving hole, a recess (114) defined in the bottom surface, and a second reflecting surface (117) arranged in the recess. The second reflecting surface faces toward the light exit surface and the first reflecting surface. The second reflecting surface is configured for directing the reflected light from the first reflecting surface to the light exit surface.

### BACKGROUND

1. Technical Field

The present invention relates generally to backlight modules and light guide plates thereof.

2. Description of Related Art

Non-emissive display devices such as LCD panels, floor mats, or logo display boards are commonly used in daily life. External light sources are applied in the display devices for providing illuminations for the non-emissive display devices. LEDs (light emitting diode) are preferred to be used in the non-emissive display devices instead of CCFLs (cold cathode fluorescent lamp) due to their high brightness, long life-span, and wide color gamut. This is disclosed in a paper on IEEE Transactions on Power Electronics, Vol. 22, No. 3, entitled “Sequential Color LED Backlight Driving System for LCD Panels”, published by Chen et al. in May, 2007, the disclosure of which is incorporated herein by reference.

A typical illumination device includes a light guide plate and an array of point light sources. Light beams emitted from the point light sources are converted to a surface light and provide illuminations for the non-emissive display devices. However, a radiation angle of each of the point light sources is usually no more than 120°, which induces a peripheral portion of the display devices to be darker than a central portion thereof. This causes the light to non-uniformly distribute over the display devices. Therefore, there is a need for improving the display efficiency of the display devices.

### SUMMARY

The present invention, in one aspect, provides a backlight module which has uniformly light distribution. The backlight module includes a light guide plate and a light source. The light guide plate includes a light exit surface, a bottom surface opposite to the light exit surface, and a receiving hole defined in the bottom surface. The light guide plate includes a first reflecting surface in the receiving hole and a light incidence surface in the receiving hole, and at least a second reflecting surface which faces toward the first reflecting surface. The light source is received in the receiving hole facing toward the first reflecting surface.

The present invention, in another aspect, provides a backlight module which has uniformly light distribution. The backlight module includes a light source for emitting light therefrom, and a light guide plate. The light guide plate includes a light exit surface, a bottom surface opposite to the light exit surface, a receiving hole defined in the bottom surface with the light source received therein, a first reflecting surface in the receiving hole facing away from the light exit surface and configured for reflecting the light emitted from the light source, a light incidence surface in the receiving hole, a recess defined in the bottom surface, and a second reflecting surface arranged in the recess. The second reflecting surface faces toward the light exit surface and the first reflecting surface. The second reflecting surface is configured for directing the reflected light from the first reflecting surface to the light exit surface.

The present invention, in another aspect, provides a light guide plate which can uniformly distributed light over a light exit surface thereof. The light guide plate includes a light exit surface, a bottom surface opposite to the light exit surface, a receiving hole defined in the bottom surface, a first reflecting surface and a light incidence surface being arranged in the receiving hole, and a second reflecting surface facing toward the first reflecting surface and the light exit surface.

Other advantages and novel features of the present backlight module and light guide plate will become more apparent from the following detailed description of preferred embodiments when taken in conjunction with the accompanying drawings, in which:

### BRIEF DESCRIPTION OF THE DRAWINGS

FIG. 1 is a schematic view of a backlight module according to a first embodiment of the present invention.

FIG. 2 is a bottom view of the backlight module of FIG. 1.

FIG. 3 is a schematic view of a backlight module according to a second embodiment of the present invention.

FIG. 4 is a schematic view of a backlight module according to a third embodiment of the present invention.

FIG. 5 is a schematic view of a backlight module according to a fourth embodiment of the present invention.

FIG. 6 is a bottom view of a backlight module according to a fifth embodiment of the present invention.

### DETAILED DESCRIPTION

Reference will now be made to the drawing figures to describe the preferred embodiment in detail.

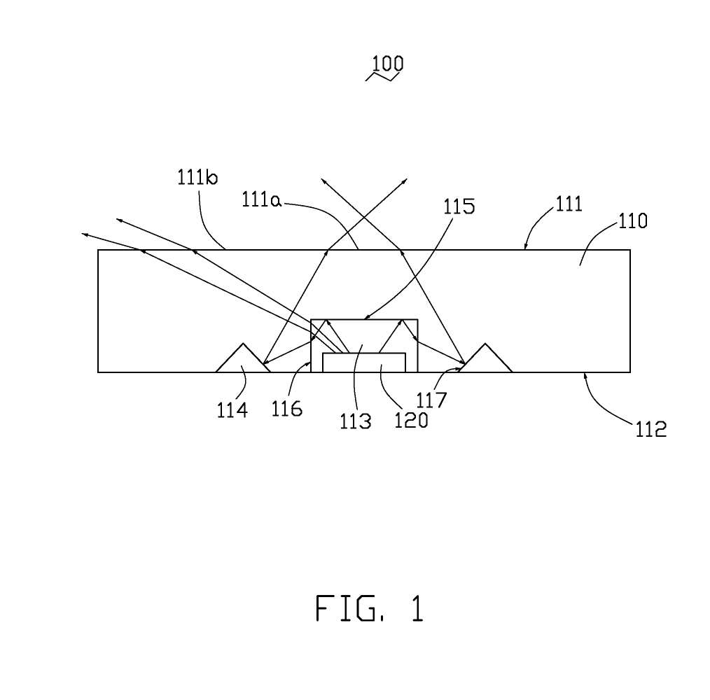

Referring to FIG. 1, a backlight module 100 according to a first embodiment of the present invention is shown. The backlight module 100 includes a light guide plate 110 and a light source 120 optically coupled with the light guide plate 110. In this embodiment, the light source 120 is preferably to be a point-like source, such as a semiconductor LED or an OLED (organic light emitting diode).

The light guide plate 110 is made of transparent material, which has a refractive index in a range between 1.4 to 1.6. The light guide plate 110 includes a planar light exit surface 111, a bottom surface 112 opposite to the light exit surface 111, and a receiving hole 113 and a recess 114 defined in the bottom surface 112. The light source 120 is received in the receiving hole 113 of the light guide plate 110. The light exit surface 111 has a first portion 111a which stands over the light source 120, and a second portion 111b which surrounds the first portion 111a.

The receiving hole 113 has a planar first reflecting surface 115, and a light incidence surface 116 extending downwardly from a periphery portion of the first reflecting surface 115. The first reflecting surface 115 substantially parallels to the light exit surface 111 of the light guide plate 110. The light source 120 locates under and faces toward to the first reflecting surface 115 of the receiving hole 113. A reflecting layer can be coated on the first reflecting surface 115 so as to increase light reflecting efficiency of the first reflecting surface 115. A reflectance of the first reflecting surface 115 is no less than 99% so that most of the light which shoots from the light source 120 towards the first reflecting surface 115 is reflected.

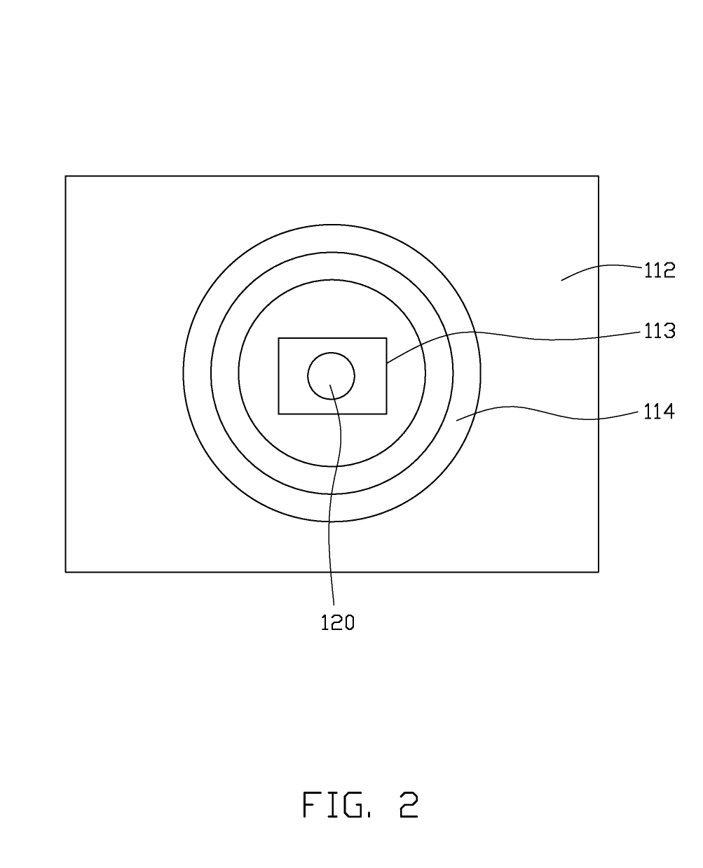

Referring to FIG. 2, the recess 114 is a continuously recess 114, which substantially has a ring-shaped configuration and is disposed around the receiving hole 113. The recess 114 locates under the second portion 111b of the light exit surface 111 and stands adjacent to the light source 120 which locates under the first portion 111a of the light exit surface 111. Each of the recess 114 has a V-shaped cross section and includes a planar second reflecting surface 117. The second reflecting surface 117 forms an acute angle with the bottom surface 112 of the light guide plate 110 and faces toward to the first reflecting surface 115 and the light incidence surface 116 of the receiving hole 113, so that light shoot towards the second reflecting surface 117 can be reflected towards the first portion 111a of the light exit surface 111. A reflecting layer (not shown) can be coated on the second reflecting surface 117 so as to increase light reflecting efficiency of the second reflecting surface 117.

In operation of the backlight module 100, one part of the light emitting from the light source 120 directly enters into the light guide plate 110 through the light incidence surface 116. The light progresses in the light guide plate 110 and exits from the light exit surface 111 of the light guide plate 110. The other part of the light emitting from the light source 120 shoots towards the first reflecting surface 115 and is reflected towards the light incidence surface 116 by the first reflecting surface 115. The light reflected by the first reflecting surface 115 enters into the light guide plate 110 through the light incidence surface 116. Some of the light entering into the light guide plate 110 after being reflected by the first reflecting surface 115 is reflected towards the light exit surface 111 by the bottom surface 112 of the light guide plate 110 and ultimately exits from the light exit surface 111. The other of the light entering into the light guide plate 110 after being reflected by the first reflecting surface 115 is reflected by the second reflecting surface 117 of the recess 114 and ultimately exits from the first portion 111a of the light exit surface 111.

That one part of the light emitted from the light source 120 of the present backlight module 100 is reflected by the first and the second reflecting surfaces 115, 117 and ultimately exits from the first portion 111a of the light exit surface 111 makes more lights concentrate on the first portion 111a of the light exit surface 111. The difference of the brightness between different portions of the light exit surface 111, i.e., between the first portion 111a and the second portion 111b of the light exit surface 111, is decreased. Therefore, the light is more uniformly distributed over the light exit surface 111 of the light guide plate 110. The display efficiency of display devices using the present backlight module 100 is accordingly increased.

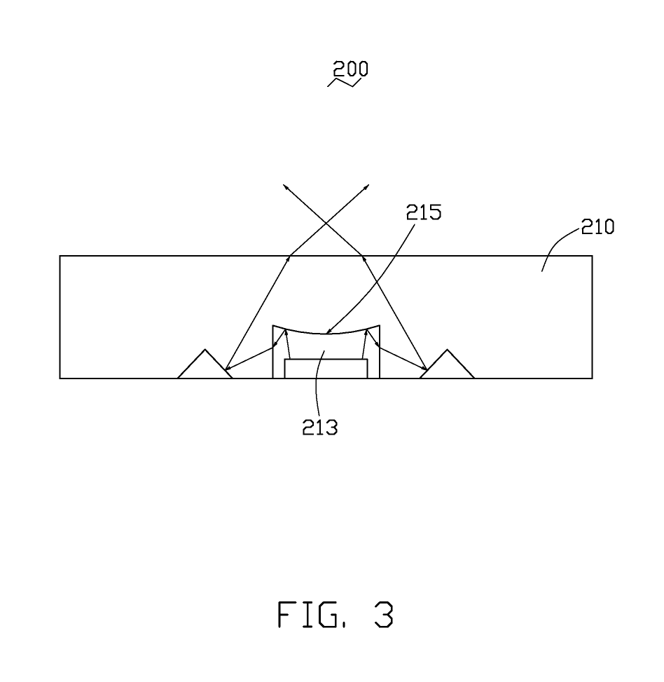

Referring to FIG. 3, a second embodiment of the present backlight module 200 is shown. The difference between the second embodiment and the first embodiment is shown as below. In the second embodiment, the first reflecting surface 215 of the receiving hole 213 of the light guide plate 210 is an arc surface which indents towards the receiving hole 213.

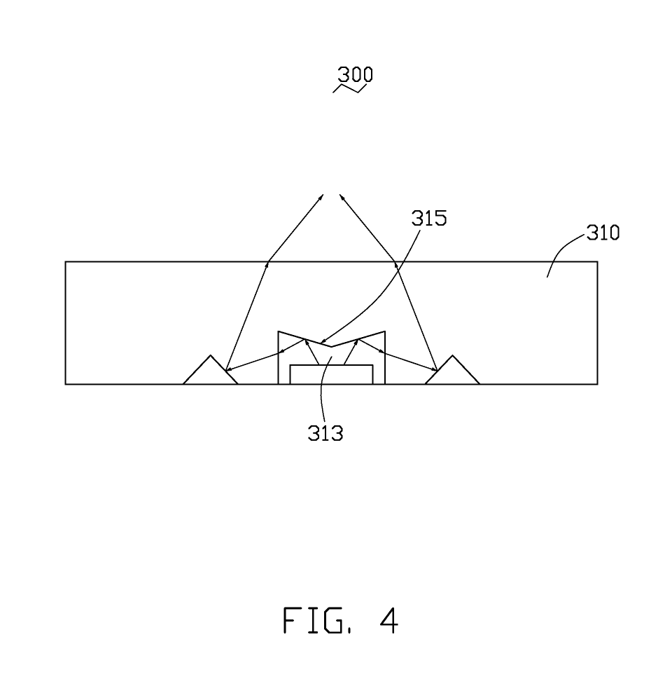

Referring to FIG. 4, a third embodiment of the present backlight module 300 is shown. The difference between the second embodiment and the first embodiment is shown as below. In the third embodiment, the first reflecting surface 315 of the receiving hole 313 of the light guide plate 310 has a V-shaped cross section. The first reflecting surface 315 may have an inverted taper-shaped configuration or the first reflecting surface 315 may comprise by two planar surfaces which forms an acute angle therebetween.

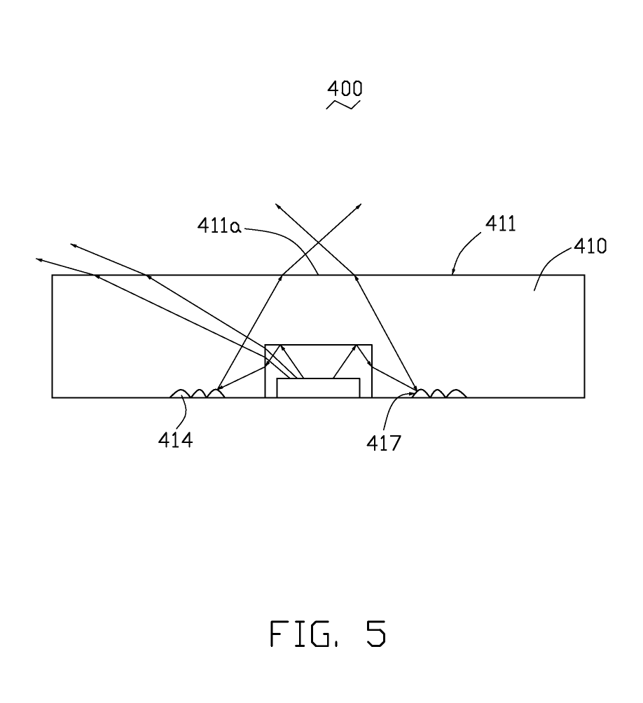

In the present backlight module 100, 200, 300, the second reflecting surface 117 is a planar surface. Alternatively, the second reflecting surface 117 may be a rough surface which comprises a plurality of reflecting points, or a plurality of grooves, or a plurality of particulates thereon. Moreover, the present recess 114 may be replaced by other reflectors such as a plurality of reflecting points 414 (as shown in FIG. 5) which are disposed at an area occupied by the present recess 114, or a plurality of grooves which are carved on the bottom surface 112 of the light guide plate 110 at the area occupied by the present recess 114. The reflecting points 414 and the grooves which replace the present recess 114 respectively form a second reflecting surface 417 (shown in FIG. 5) for reflecting light towards the first portion 411a of the light exit surface 411 of the light guide plate 400.

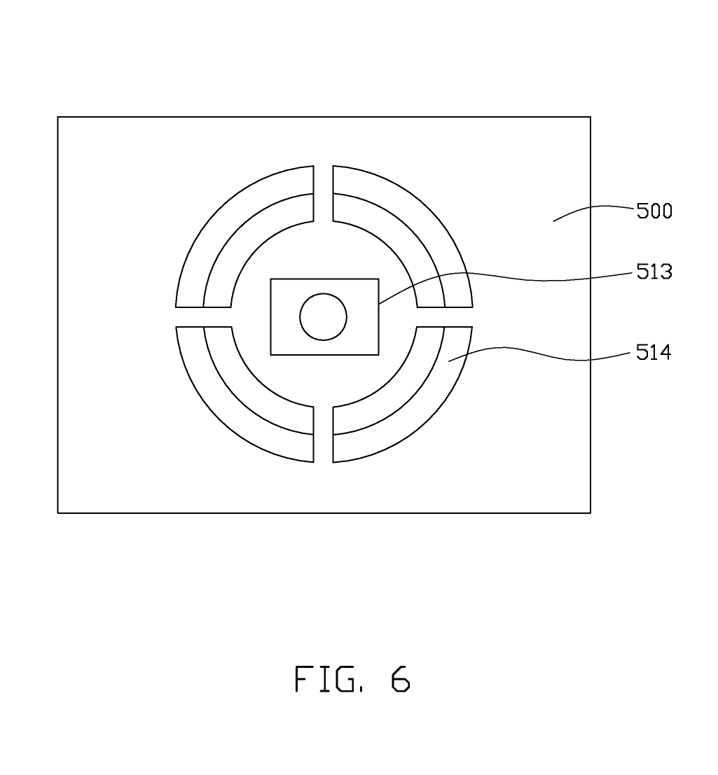

In the present backlight module 100, 200, 300, the recess 114 is ring-shaped in profile. Alternatively, referring to FIG. 6, the recess 114 may be replaced by a plurality of recesses 514 which are discretely distributed around the receiving hole 513 of the light guide plate 500. Each of the recesses 514 has a V-shaped cross section and is arc-shaped when viewed from bottom. Alternatively, each of the recesses 514 may have a tapered configuration which has a V-shaped cross section and is round shaped when viewed from bottom.

It is to be understood, how ever, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module comprising:
a light guide plate comprising a light exit surface, a bottom surface opposite to the light exit surface, and a receiving hole defined in the bottom surface, the light guide plate comprising a first reflecting surface in the receiving hole and a light incidence surface in the receiving hole, and at least a second reflecting surface which faces toward the first reflecting surface; and
a light source received in the receiving hole facing toward the first reflecting surface.

2. The backlight module of claim 1, wherein the first reflecting surface is planar surface.

3. The backlight module of claim 1, wherein the first reflecting surface is arc surface.

4. The backlight module of claim 1, wherein the first reflecting surface has a V-shaped cross section.

5. The backlight module of claim 1, wherein the light guide plate includes a plurality of discrete recesses surrounding the receiving hole, the second reflecting surface being arranged in the recesses.

6. The backlight module of claim 1, wherein the light guide plate includes a ring-shaped recess surrounding the receiving hole, the second reflecting surface being arranged in the ring-shaped recess.

7. The backlight module of claim 1, wherein the light guide plate is made of transparent material, which has a refractive index in a range from 1.4 to 1.6.

8. The backlight module of claim 1, wherein a reflectance of the first reflecting surface is no less than 99%.

9. The backlight module of claim 1, wherein the light source is a light emitting diode.

10. A light guide plate comprising:
a light exit surface;
a bottom surface opposite to the light exit surface;
a receiving hole defined in the bottom surface, a first reflecting surface and a light incidence surface being arranged in the receiving hole; and
a second reflecting surface facing toward the first reflecting surface and the light exit surface.

11. The light guide plate of claim 10, wherein the first reflecting surface is planar surface.

12. The light guide plate of claim 10, wherein the first reflecting surface is arc surface.

13. The light guide plate of claim 10, wherein the first reflecting surface has a V-shaped cross section.

14. The light guide plate of claim 10, wherein a reflectance of the first reflecting surface is no less than 99%.

15. The light guide plate of claim 10, wherein the light guide plate includes a plurality of discrete recesses surrounding the receiving hole, the second reflecting surface being arranged in the recesses.

16. The light guide plate of claim 10, wherein the light guide plate includes a ring-shaped recess surrounding the receiving hole, the second reflecting surface being arranged in the ring-shaped recess.

17. A backlight module comprising:
a light source for emitting light therefrom;
a light guide plate comprising:
a light exit surface;
a bottom surface opposite to the light exit surface;
a receiving hole defined in the bottom surface with the light source received therein;
a first reflecting surface in the receiving hole facing away from the light exit surface, the first reflecting surface being configured for reflecting the light emitted from the light source;
a light incidence surface in the receiving hole;
a recess defined in the bottom surface; and
a second reflecting surface arranged in the recess, the second reflecting surface facing toward the light exit surface and the first reflecting surface, the second reflecting surface being configured for directing the reflected light from the first reflecting surface to the light exit surface.

18. The light guide plate of claim 17, wherein the second reflecting surface surrounds the receiving hole.
